(19) United States
(12) Patent Application Publication
(10) Pub. No.: US 2011/0285211 A1
(43) Pub. Date: Nov. 24, 2011

(54) WIRELESS POWER SUPPLY SYSTEM

(75) Inventors: Yuki Endo, Tokyo (JP); Yasuo Furukawa, Tokyo (JP)

(73) Assignee: ADVANTEST CORPORATION, Tokyo (JP)

(21) Appl. No.: 13/109,411

(22) Filed: May 17, 2011

Related U.S. Application Data
(60) Provisional application No. 61/346,872, filed on May 20, 2010.

(51) Int. Cl. H02J 17/00

(52) U.S. Cl. 307/104

(57) ABSTRACT

A wireless power receiving apparatus comprises a bridge circuit and a control unit configured to control the bridge circuit. A wireless power supply apparatus transmits, to the wireless power receiving apparatus, an electric power signal and a control signal which indicates a control timing for the bridge circuit. A receiver receives the control signal transmitted from the wireless power supply apparatus. A control unit controls the bridge circuit according to the control signal.

### BACKGROUND OF THE INVENTION

1. Field of the Invention

The present invention relates to a wireless power supply technique.

2. Description of the Related Art

In recent years, wireless (contactless) power transmission has been receiving attention as a power supply technique for electronic devices such as cellular phone terminals, laptop computers, etc., or for electric vehicles. Wireless power supply transmission can be classified into three principal methods: an electromagnetic induction method, an electromagnetic wave reception method, and an electric field/magnetic field resonance method.

The electromagnetic induction method is employed to supply electric power at a short range (several cm or less), which enables electric power of several hundred watts to be transmitted in a band that is equal to or lower than several hundred kHz. The power use efficiency thereof is on the order of 60% to 98%.

In a case in which electric power is to be supplied over a relatively long range of several meters or more, the electromagnetic wave reception method is employed. The electromagnetic wave reception method allows electric power of several watts or less to be transmitted in a band between medium waves and microwaves. However, the power use efficiency thereof is small. The electric field/magnetic field resonance method has been receiving attention as a method for supplying electric power with relatively high efficiency at a middle range on the order of several meters (see Non-patent document 1).

### RELATED ART DOCUMENTS

### Patent Documents

### Non-Patent Document 1

A. Karalis, J. D. Joannopoulos, M. Soljacic, “Efficient wireless non-radiative mid-range energy transfer” ANNALS of PHYSICS Vol. 323, January 2008, pp. 34-48.

The resonant frequency is important factor in magnetic field (electric field) resonant-type power transmission. Such power transmission requires precise frequency matching. However, in actuality, the resonant frequency fluctuates due to various kinds of causes. It is difficult for the power receiving apparatus side to tune such a fluctuating resonant frequency based upon the magnetic field (electric field) itself transmitted from the power supply apparatus. This is why, in some cases, the resonant frequency to be detected by the power receiving apparatus further fluctuates according to the resonant frequency of the power receiving apparatus and the phase state thereof.

### SUMMARY OF THE INVENTION

The present invention has been made in order to solve the aforementioned problem. Accordingly, it is an exemplary purpose of an embodiment of the present invention to provide a wireless power supply apparatus, a wireless power receiving apparatus, and a wireless power supply system configured to be capable of precisely tuning the resonant frequency or the phase thereof.

An embodiment of the present invention relates to a wireless power receiving apparatus configured to receive an electric power signal, including any one of an electric field, a magnetic field, and an electromagnetic field. The wireless power receiving apparatus comprises: a reception coil configured to receive the electric power signal; a bridge circuit connected to the reception coil, and configured such that the on/off state of each internal switch thereof is capable of switching between a first state and a second state; a receiver configured to receive a control signal which is transmitted from the power supply apparatus, and which includes at least one of frequency information and phase information with respect to switching between the first state and the second state; and a control unit configured to switch the state of the bridge circuit between the first state and the second state according to the control signal.

The Q value of the wireless power receiving apparatus changes according to the switching timing at which the bridge circuit is switched between the first state and the second state, i.e., according to the resonant frequency and the phase thereof. That is to say, the electric power supplied from the wireless power supply apparatus to the wireless power receiving apparatus, i.e., the power supply efficiency, changes according to the switching timing at which the wireless power receiving apparatus is switched between the first state and the second state. The wireless power supply apparatus has information with respect to the electric power supplied from the wireless power supply apparatus itself to the wireless power receiving apparatus. Thus, by generating a control signal such that the electric power becomes the maximum value or a desired value, such an arrangement provides a flexible control operation for the resonant frequency or the phase thereof in the power supply apparatus so as to supply a desired amount of electric power.

Also, the control signal may include both the frequency information and the phase information. With such an arrangement, the control signal may be a pulse signal which indicates a switching timing of switching between the first state and the second state.

Also, the control signal may include frequency information with respect to switching between the first state and the second state. With such an arrangement, the power reception apparatus tunes the frequency according to the control signal, and the power supply apparatus adjusts the phase of the electric power signal, thereby controlling the amount of electric power supplied.

Also, the control signal may be configured as a light signal. Also, the control signal may be configured as a radio wave signal.

Also, the control signal may be encrypted. Also, the wireless power receiving apparatus may further comprise a decryption unit configured to decrypt the control signal received by the receiver. Such an arrangement allows electric power to be selectively supplied only to a wireless power receiving apparatus having a key required to decode the control signal.

Also, the bridge circuit may comprise: a first switch and a second switch sequentially arranged in series so as to form a closed loop together with the reception coil, and arranged such that a connection node that connects the first switch and the second switch is connected to a second terminal of a capacitor arranged such that a first terminal thereof is set to a fixed electric potential; and a third switch and a fourth switch sequentially arranged in series so as to form a path arranged in parallel with the first switch and the second switch, and arranged such that a connection node that connects the third switch and the fourth switch is set to a fixed electric potential. Also, the control unit may be configured to switch the state, at a timing indicated by the control signal, between a first state in which the first switch and the fourth switch are on and the second switch and the third switch are off, and a second state in which the first switch and the fourth switch are off and the second switch and the third switch are on.

The control unit may be configured to provide, as states which can be switched according to the control signal, at least one of a third state in which both the first switch and the second switch are on, and a fourth state in which both the third switch and the fourth switch are on, in addition to the first state and the second state. In the third state or the fourth state, the reception coil, the resonance capacitor, and the two switches in the on state are connected in series to form a resonance loop, thereby providing the highest Q value.

The control unit may be configured to provide, as a state which can be switched according to the control signal, a fifth state in which all the switches from the first switch through the fourth switch are off, in addition to the first state and the second state. By providing such a fifth state during transition from the first state to the second state and during transition from the second state to the first state, and by adjusting the length of the fifth state while maintaining the switching period at a constant length, such an arrangement is capable of adjusting the effective resonant frequency without changing the circuit constants of the reception coil and the resonance capacitor.

Also, the first switch and the second switch may form a closed loop together with an auxiliary coil densely coupled with the reception coil, instead of the reception coil.

Another embodiment of the present invention relates to a wireless power supply apparatus configured to transmit, to a wireless power receiving apparatus, an electric power signal, including any one of an electric field, a magnetic field, and an electromagnetic field. The wireless power receiving apparatus comprises: a reception coil configured to receive the electric power signal; a capacitor arranged such that a first terminal thereof is set to a fixed electric potential; a bridge circuit arranged between the reception coil and the capacitor, and configured such that the on/off state of each internal switch thereof is capable of switching between a first state and a second state; a receiver configured to receive a control signal which is transmitted from the power supply apparatus, and which includes at least one of frequency information and phase information with respect to switching between the first state and the second state; and a control unit configured to switch the state of the bridge circuit between the first state and the second state according to the control signal. The wireless power supply apparatus comprises: a transmission coil configured to transmit the electric power signal; a control signal generating unit configured to generate the control signal; and a transmitter configured to transmit the control signal.

The Q value of the wireless power receiving apparatus changes according to the switching timing at which the bridge circuit is switched between the first state and the second state. That is to say, the electric power supplied from the wireless power supply apparatus to the wireless power receiving apparatus, i.e., the power supply efficiency, changes according to the switching timing at which the wireless power receiving apparatus is switched between the first state and the second state. The wireless power supply apparatus has information with respect to the electric power supplied from the wireless power supply apparatus itself to the wireless power receiving apparatus. Thus, by generating a control signal such that the electric power becomes the maximum value or a desired value, such an arrangement is capable of controlling an amount of electric power supplied as desired.

Also, the control signal may include both the frequency information and the phase information. With such an arrangement, the control signal may be a pulse signal which indicates a switching timing of switching between the first state and the second state.

Also, the control signal generating unit may be configured to determine, based upon a voltage applied to the transmission coil and a current that flows through the transmission coil, a timing of switching the state between the first state and the second state.

Also, the control signal may include only frequency information with respect to switching between the first state and the second state. Also, the wireless power supply apparatus may adjust the phase of the electric power signal transmitted from the transmission coil, based upon a voltage applied to the transmission coil and a current that flows through the transmission coil.

Also, the control signal may be configured as a visible light signal. Also, the transmitter may be configured to emit the control signal configured as a visible light signal in an area in which the wireless power receiving apparatus can receive the electric power signal. Using, as a landmark, the illumination area in which the control signal is emitted, such an arrangement allows the user of a device mounting such a wireless power receiving apparatus to acquire the information with respect to the position at which the wireless power receiving apparatus can receive electric power.

Also, the wireless power supply apparatus may further comprise an encryption unit configured to encrypt the control signal.

Such an arrangement allows electric power to be selectively supplied only to a wireless power receiving apparatus having a key (code) required to decode the control signal.

Yet another embodiment of the present invention relates to a wireless power receiving apparatus. The wireless power receiving apparatus comprises: a reception coil configured to receive the electric power signal; a resonance capacitor arranged such that it forms a resonance circuit together with the reception coil; a receiver configured to receive a control signal which is transmitted from the power supply apparatus, and which indicates the frequency of the electric power signal; and a control unit configured to change the impedance of the resonance circuit according to the control signal such that resonance occurs between the resonance circuit and the electric power signal.

Also, the control signal may be encrypted. Also, the wireless power receiving apparatus may further comprise a decryption unit configured to decrypt the control signal received by the receiver.

Yet another embodiment of the present invention relates to a wireless power receiving apparatus. The wireless power supply apparatus comprises: a transmission coil configured to transmit an electric power signal; a control signal generating unit configured to generate a control signal; and a transmitter configured to transmit the control signal.

Also, the wireless power supply apparatus may further comprise an encryption unit configured to encrypt the control signal.

Also, the control signal may be configured as a visible light signal. Also, the transmitter may be configured to emit the control signal configured as a visible light signal in an area in which the wireless power receiving apparatus can receive the electric power signal.

Yet another embodiment of the present invention relates to a wireless power supply system. The wireless power supply system comprises: any one of the aforementioned wireless power supply apparatuses; and any one of the aforementioned wireless power receiving apparatuses.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram which shows a configuration of a wireless power supply system according to a first embodiment;

FIGS. 2A and 2B are circuit diagrams each showing an operation of a wireless power receiving apparatus shown in FIG. 1;

FIG. 3 is a waveform diagram which shows the operation of the wireless power receiving apparatus shown in FIG. 1;

FIG. 4 is a waveform diagram which shows the operation of a synchronous rectifier circuit as a comparison technique;

FIG. 5 is a circuit diagram which shows a configuration of a wireless power receiving apparatus according to a first modification;

FIG. 6 is a circuit diagram which shows a configuration of a wireless power receiving apparatus according to a second modification;

FIG. 7 is a circuit diagram which shows a configuration of a wireless power receiving apparatus according to a second embodiment;

FIG. 8 is a time chart which shows the operation of the wireless power supply system shown in FIG. 7;

FIG. 9 is a diagram which shows a configuration of a wireless power supply system according to a first modification;

FIG. 10 is a diagram which shows a configuration of a wireless power supply system according to a second modification;

FIG. 11 is a diagram which shows a configuration of a wireless power supply system according to a third embodiment; and

FIG. 12 is a diagram which shows an example of installation of the wireless power supply system according to the second or third embodiment.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

### First Embodiment

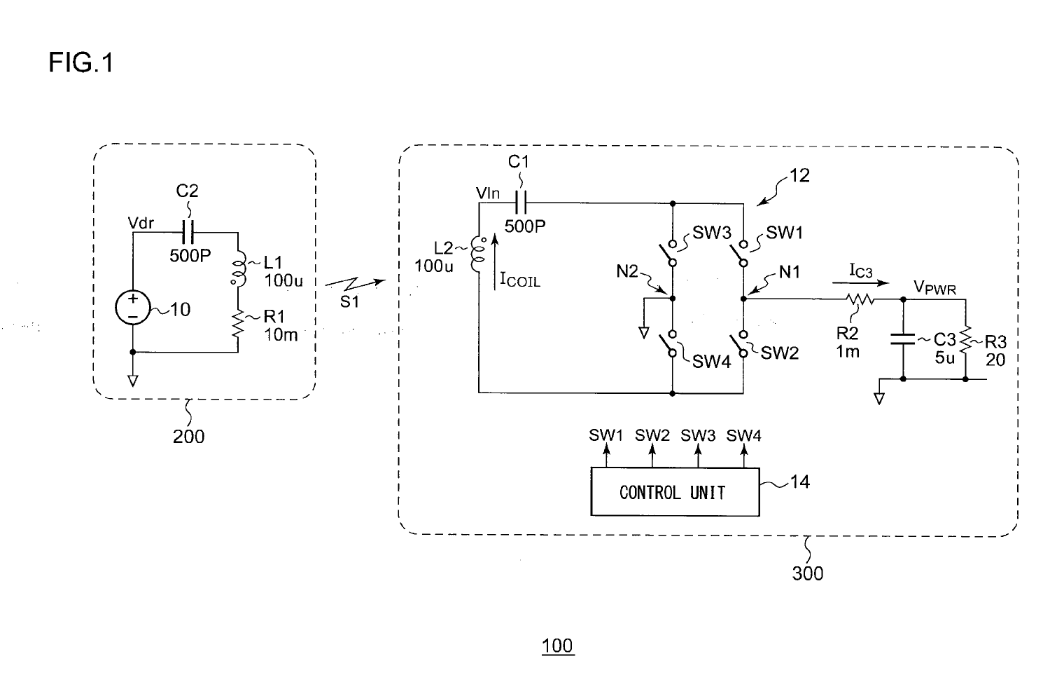

FIG. 1 is a circuit diagram which shows a configuration of a wireless power supply system 100 according to a first embodiment. In this circuit diagram, circuit constants are shown for exemplary purposes. However, such circuit constants are not intended to limit the present invention. The wireless power supply system 100 includes a wireless power supply apparatus 200 and a wireless power receiving apparatus 300. First, description will be made regarding the configuration of the wireless power supply apparatus 200.

The wireless power supply apparatus 200 transmits an electric power signal to the wireless power receiving apparatus 300. As an electric power signal S1, the wireless power supply system 100 uses the near-field component (electric field, magnetic field, or electromagnetic field) of electromagnetic waves that has not become radio waves.

The wireless power supply apparatus 200 includes an AC power supply 10, a transmission coil L1, and a capacitor C2. The AC power supply 10 generates an electric signal S2 having a predetermined frequency, or subjected to frequency-modulation, phase-modulation, amplitude-modulation, or the like. For simplicity of description and ease of understanding, description will be made in the present embodiment regarding an arrangement in which the electric signal S2 is an AC signal having a constant frequency. For example, the frequency of the electric signal S2 is selected from a range between several hundred kHz and several MHz.

The transmission coil L1 is an antenna configured to emit the electric signal S2 generated by the AC power supply 10, as a near-field signal (electric power signal) including any one of an electric field, magnetic field, or electromagnetic field. The transmission capacitor C2 is arranged in series with the transmission coil L1. The resistor R1 represents the resistance component that is in series with the transmission coil L1.

The above is the configuration of the wireless power supply apparatus 200. Next, description will be made regarding the configuration of the wireless power receiving apparatus 300.

The wireless power receiving apparatus 300 receives the electric power signal S1 transmitted from the wireless power supply apparatus 200. The wireless power receiving apparatus 300 includes a reception coil L2, a resonance capacitor C1, an H-bridge circuit 12, a control unit 14, and a power storage capacitor C3. Together with the reception coil L2, the resonance capacitor C1 forms an oscillation circuit.

The reception coil L2 receives the electric power signal S1 from the transmission coil L1. An induced current (resonant current) I_{COIL} that corresponds to the electric power signal S1 flows through the reception coil L2. The wireless power receiving apparatus 300 acquires electric power via the induced current thus generated.

A first terminal of the power storage capacitor C3 is grounded, and the electric potential thereof is fixed. The H-bridge circuit 12 includes a first switch SW1 through a fourth switch SW4. The first switch SW1 and the second switch SW2 are sequentially connected in series so as to form a closed loop including the reception coil L2 and the resonance capacitor C1. A connection node N1 that connects the first switch SW1 and the second switch SW2 is connected to a second terminal of the power storage capacitor C3. A loss resistance R2 represents power loss that occurs in the wireless power receiving apparatus 300. A load resistor R3 represents a load driven by the electric power stored in the power storage capacitor C3, and does not represents a resistor arranged as a circuit component. A voltage V_{PWR} that develops at the power storage capacitor C3 is supplied to the load resistance R3.

The third switch SW3 and the fourth switch SW4 are sequentially arranged in series so as to form a path that is parallel to a path that includes the first switch SW1 and the second switch SW2. A connection node N2 that connects the third switch SW3 and the fourth switch SW4 is grounded, and has a fixed electric potential.

The first switch SW1 through the fourth switch SW4 are each configured as a MOSFET (Metal Oxide Semiconductor Field Effect Transistor), a bipolar transistor, or an IGBT (Insulated Gate Bipolar Transistor), or the like.

A control unit 14 controls the first switch SW1 through the fourth switch SW4.

Specifically, the control unit 14 is configured to be capable of switching the state between a first state φ1 and a second state φ2. In the first state φ1, the first switch SW1 and the fourth switch SW4 are on, and the second switch SW2 and the third switch SW3 are off. In the second state φ2, the first switch SW1 and the fourth switch SW4 are off, and the second switch SW2 and the third switch SW3 are on.

The induced current I_{COIL} that develops at the reception coil L2 has an AC waveform. The control unit 14 switches the state between the first state φ1 and the second state φ2 at timings at which the induced current I_{COIL} becomes a value in the vicinity of the peak and it becomes a value in the vicinity of the bottom.

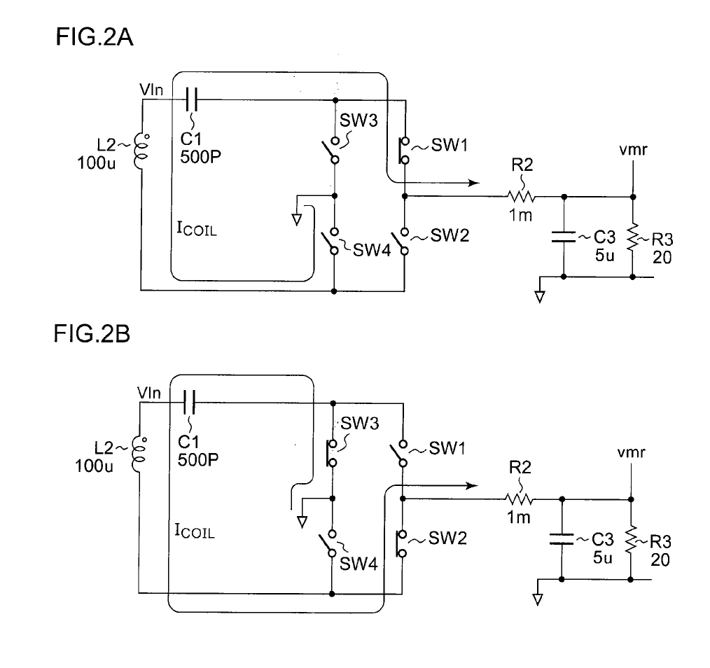

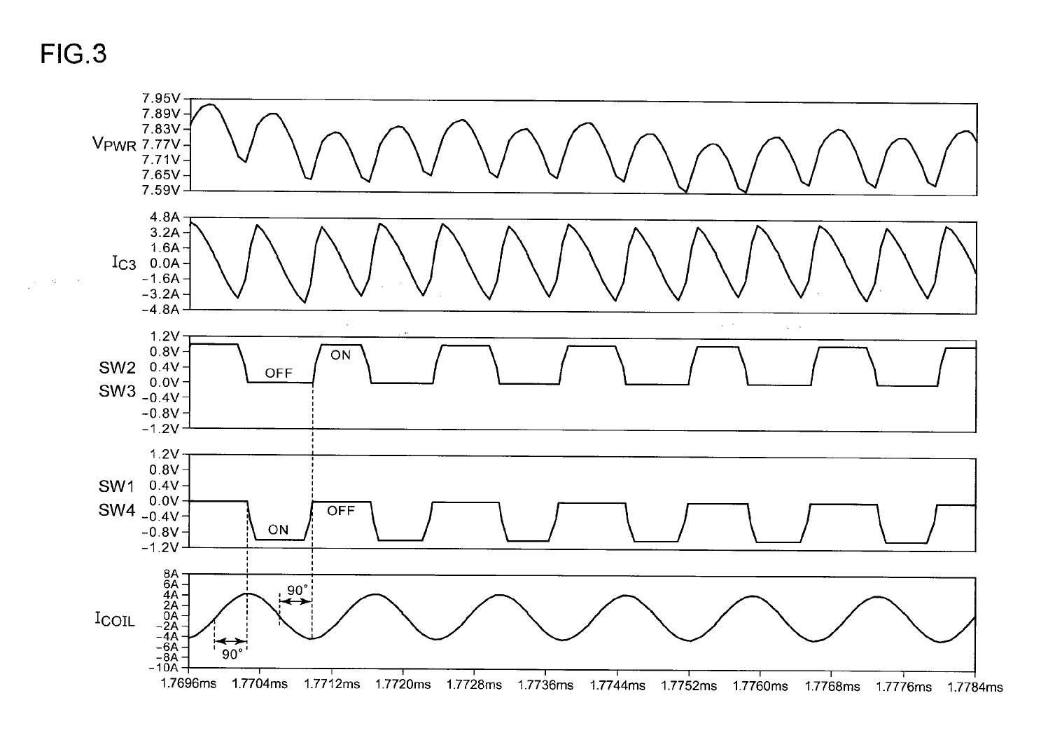

The above is the configuration of the wireless power supply system 100. Next, description will be made regarding the operation thereof. FIGS. 2A and 2B are circuit diagrams each showing the operation of the wireless power receiving apparatus 300 shown in FIG. 1. FIG. 2A shows the state of each switch and the current in the first state φ1, and FIG. 2B shows the state of each switch and the current in the second state φ2. FIG. 3 is a waveform diagram which shows the operation of the wireless power receiving apparatus 300 shown in FIG. 1. From the top and in the following order, FIG. 3 shows the voltage V_{PWR} that develops at the power storage capacitor C3, a current I_{C3} that flows into the power storage capacitor C3, the states of the second switch SW2 and the third switch SW3, the states of the first switch SW1 and the fourth switch SW4, and the induced current I_{COIL} that develops at the reception coil L2.

In FIG. 3, the states of the second switch SW2 and the third switch SW3 each correspond to the fully-on state when the voltage is +1 V, and correspond to the off state when the voltage is 0 V. On the other hand, the states of the first switch SW1 and the fourth switch SW4 each correspond to the fully-on state when the voltage is −1 V, and correspond to the off state when the voltage is 0 V. The voltage level which indicates the state of each switch is determined for convenience. The waveform is shown with the direction of the arrow shown in FIG. 1 as the positive direction.

First, the AC electric power signal S1 is transmitted from the wireless power supply apparatus 200 shown in FIG. 1. The induced current I_{COIL}, which is an AC current, flows through the reception coil L2 according to the electric power signal S1.

The control unit 14 controls the on/off state of each of the first switch SW1 through the fourth switch SW4 in synchronization with the electric power signal S1. In the first state φ1, the current I_{C3} flows from the ground terminal via the fourth switch SW4, the reception coil L2, the resonance capacitor C1, and the first switch SW1, as shown in FIG. 2A. In the second state φ2, the current I_{C3} flows from the ground terminal via the third switch SW3, the reception coil L2, the resonance capacitor C1, and the second switch SW2, as shown in FIG. 2B.

In a case in which the power storage capacitor C3 has a sufficient capacitance to function as a voltage source, such a power storage capacitor C3 can be used as a driving voltage source for the resonance circuit. Thus, by coupling the power storage capacitor C3 with the reception coil L2 at a phase shifted by 90 degrees with respect to the zero-crossing point of the induced current (resonance current) I_{COIL}, such an arrangement is capable of compensating for the loss due to the resistance component of the reception coil L2 and so forth by means of the power storage capacitor C3 functioning as a power supply.

The Q value of the resonance circuit is inversely proportional to the resistance R. However, if the power storage capacitor C3 can perfectly compensate for the power loss due to the resistance R, the resistance R can be regarded as zero, thereby providing a circuit equivalent to a resonance circuit having an infinite Q value.

As described above, with the wireless power receiving apparatus 300 according to the embodiment, the H-bridge circuit 12 applies the voltage generated by the power storage capacitor C3 to the reception coil L2 at a suitable timing. Thus, such an arrangement provides a dramatically improved effective Q value.

The wireless power receiving apparatus 300 having a high Q value provides high-efficiency electric power transmission even if the coupling coefficient k between the transmission coil L1 and the reception coil L2 is low, i.e., even if there is a great distance between the wireless power supply apparatus 200 and the wireless power receiving apparatus 300.

It should be noted that the timing at which the state of each of the first switch SW1 through the fourth switch SW4 is switched on and off is not restricted to such an arrangement described with reference to FIG. 3. By controlling the on/off switching timing, such an arrangement is capable of controlling the Q value of the resonance circuit. In a case of intentionally providing a low Q value, such an arrangement may intentionally shift the on/off switching timing from that shown in FIG. 3.

Furthermore, with such a configuration shown in FIG. 1, the H-bridge circuit 12 configured to raise the Q value also functions as a rectifier circuit. Thus, such an arrangement has another advantage in that there is no need to provide a rectifier circuit including a diode or the like as an additional circuit, unlike a modification described later.

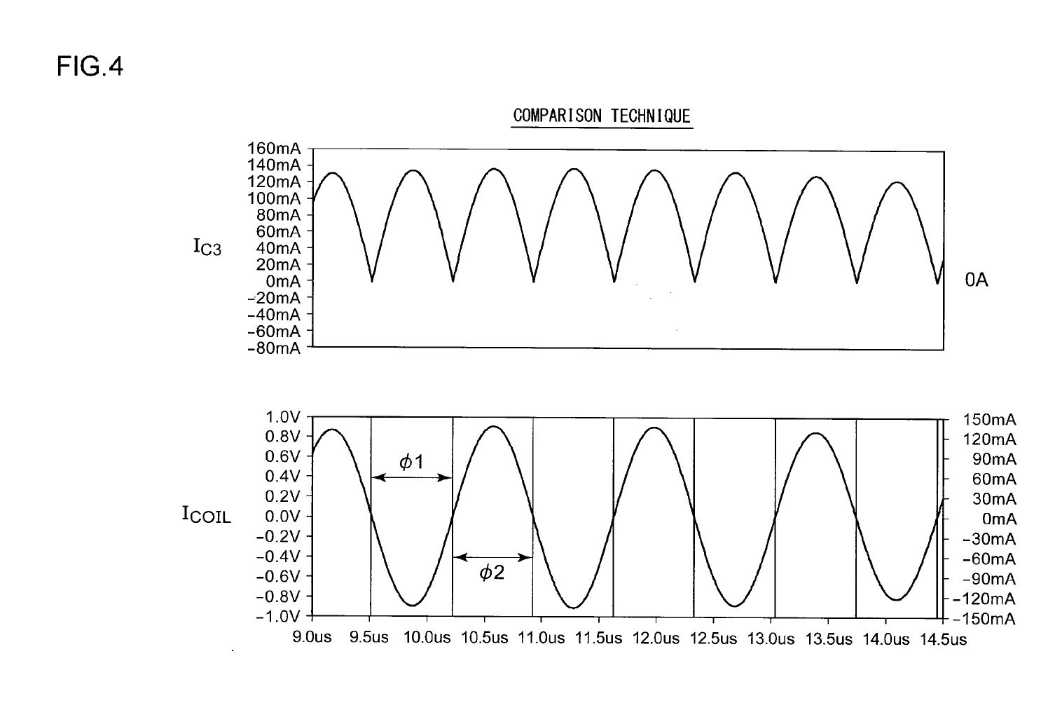

It should be noted that the aforementioned H-bridge circuit 12 must not be identified as a typical synchronous rectifier circuit. FIG. 4 is a waveform diagram which shows the operation of a synchronous rectifier circuit as a comparison technique. With such a synchronous rectifier circuit, the state is switched between the first state φ1 and the second state φ2 at a timing at which a zero-crossing point occurs in the resonance current I_{COIL}. In this case, the current I_{C3} that flows into the power storage capacitor C3 has a waveform that has been subjected to full-wave rectification. It should be noted that, unlike rectification by means of a diode, voltage loss does not occur in this rectification. Such a synchronous rectifier circuit cannot compensate for the loss that occurs in the resonance circuit. Accordingly, such an arrangement does not provide an improved Q value.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

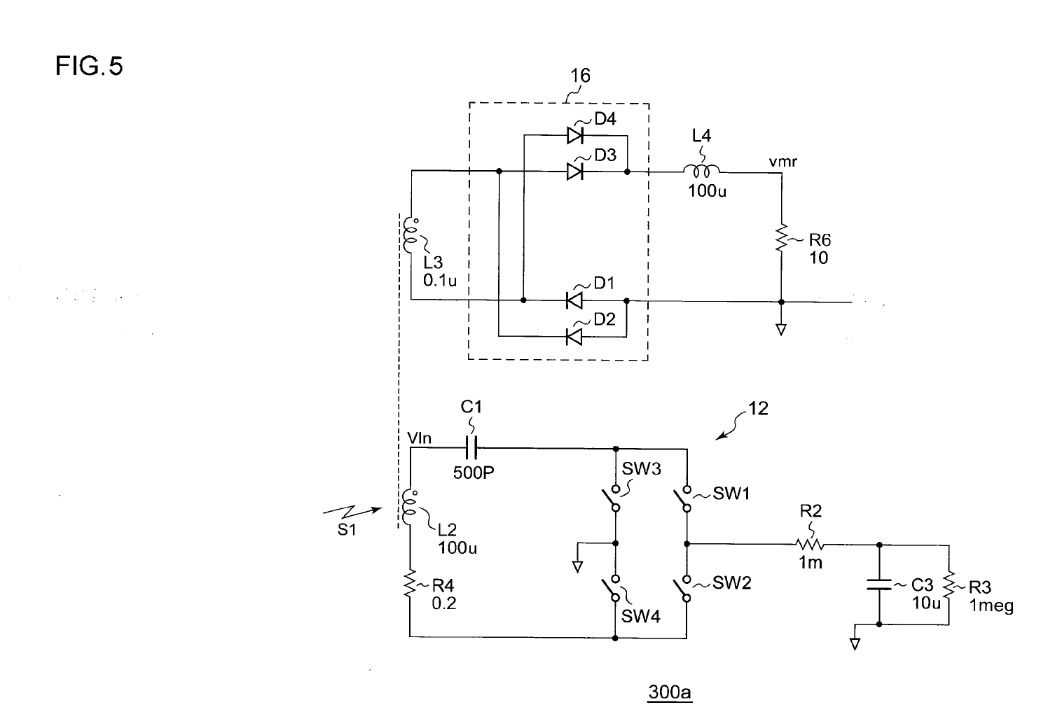

FIG. 5 is a circuit diagram which shows a configuration of a wireless power receiving apparatus 300a according to a first modification. It should be noted that a part of the circuit components that overlaps those shown in FIG. 1 are not shown. The point of difference between the wireless power receiving apparatus 300a shown in FIG. 5 and the wireless power receiving apparatus 300 shown in FIG. 1 is the position of the load. Specifically, in FIG. 5, the resistor R6 functions as a load, instead of the resistor R3. The resistor R3 arranged in parallel with the power storage capacitor C3 has a negligible effect.

The wireless power receiving apparatus 300a shown in FIG. 5 includes an auxiliary coil L3, a rectifier circuit 16, and an inductor L4, in addition to the wireless power receiving apparatus 300 shown in FIG. 1.

The auxiliary coil L3 is densely coupled with the reception coil L2. The rectifier circuit 16 performs full-wave rectification of a current I_{L3} that flows through the auxiliary coil L3. The inductor L4 is arranged on the output side of the rectifier circuit 16 in series with the load resistor R6.

With such a configuration shown in FIG. 5, the Q value of the resonance circuit comprising the reception coil L2 and the resonance capacitor C1 is raised by the Q value amplifier circuit including the H-bridge circuit 12 and the power storage capacitor C3. As a result, a large amount of current I_{L3} is induced in the auxiliary coil L3 densely coupled with the reception coil L2, thereby providing a large amount of electric power to the load resistor R6.

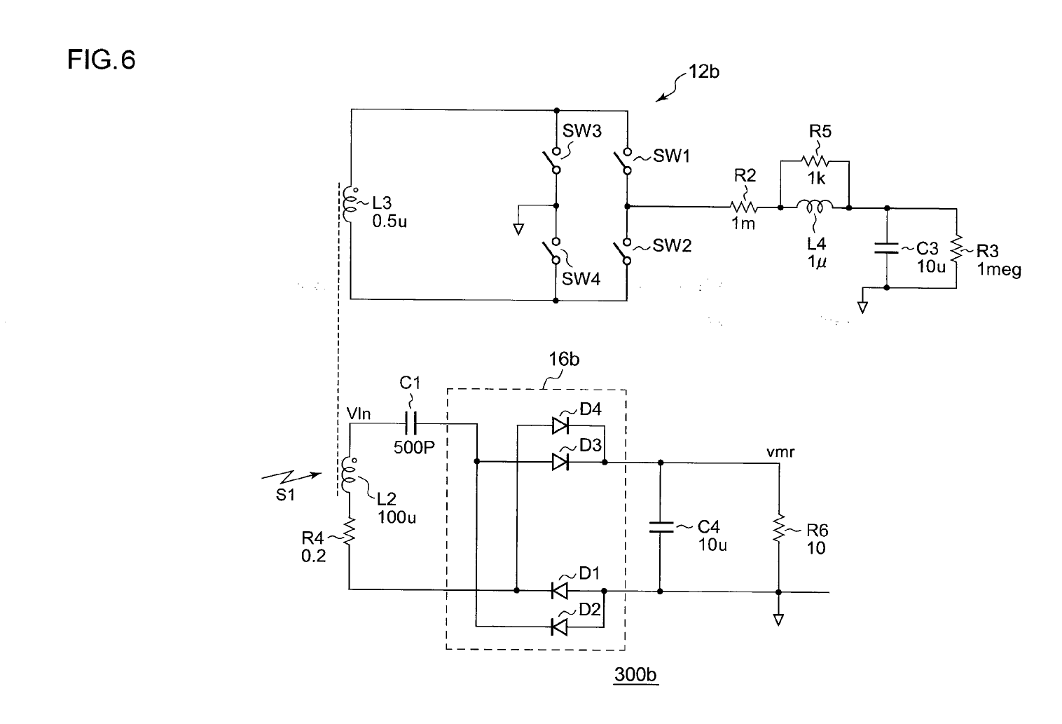

FIG. 6 is a circuit diagram which shows a configuration of a wireless power receiving apparatus 300b according to a second modification. The wireless power receiving apparatus 300b includes an auxiliary coil L3 densely coupled with the reception coil L2. With such an arrangement, an H-bridge circuit 12b is connected to the auxiliary coil L3, instead of the reception coil L2. An inductor L4 and a resistor R5 connected in parallel are arranged between the H-bridge circuit 12b and the power storage capacitor C3.

The rectifier circuit 16b performs full-wave rectification of the current that flows through the resonance circuit including the reception coil L2 and the resonance capacitor C1. The power storage capacitor C4 is arranged on the output side of the rectifier circuit 16b, and is configured to smooth the current thus subjected to full-wave rectification by the rectifier circuit 16b. The voltage that develops at the power storage capacitor C4 is supplied to the load resistor R6.

With such a configuration shown in FIG. 6, via the auxiliary coil L3, a Q value amplifier circuit comprising the H-bridge circuit 12b and the power storage capacitor C3 is capable of raising the Q value of the resonance circuit that includes the reception coil L2 and the resonance capacitor C1. As a result, such an arrangement is capable of receiving electric power with high efficiency.

### Second Embodiment

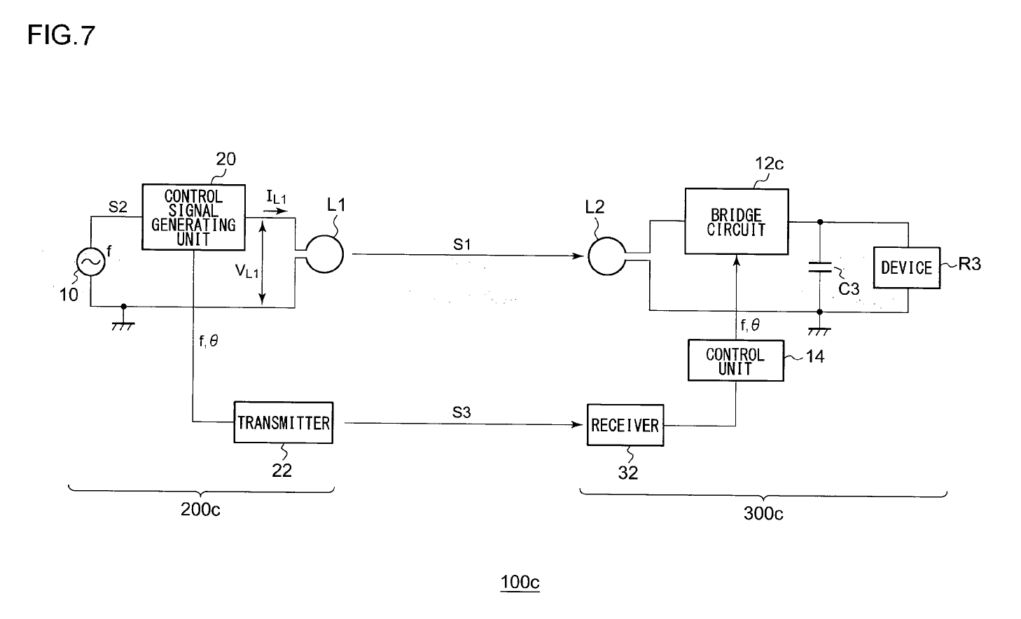

FIG. 7 is a diagram which shows a configuration of a wireless power supply system 100c according to a second embodiment. The wireless power supply system 100c includes a wireless power supply apparatus 200c and a wireless power receiving apparatus 300c.

The wireless power receiving apparatus 300c includes a reception coil L2, a power storage capacitor C3, an H-bridge circuit 12, a control unit 14, a receiver 32, and a device R3 which acts as a load.

The reception coil L2 receives an electric power signal S1. The power storage capacitor C3 is arranged such that one terminal thereof is set to a fixed electric potential. The bridge circuit 12c is arranged between the reception coil L2 and the capacitor C3, and is configured such that the on state and the off state of each internal switch thereof can be switched between a first state φ1 and a second state φ2. The bridge circuit 12c may be configured as the H-bridge circuit 12 shown in FIG. 1. Also, the bridge circuit 12c may be configured as any other configuration, such as a half-bridge circuit. That is to say, the configuration of the bridge circuit 12c is not restricted in particular, as long as the Q value of the receiver side can be controlled according to the switching timing between the first state φ1 and the second state φ2. Also, the configuration of the connection connecting the bridge circuit 12c, the reception coil L2, and the device R3 is not restricted to such an arrangement shown in FIG. 7. Also, such a configuration shown in FIG. 5 or FIG. 6 may be employed.

The receiver 32 receives a control signal S3 transmitted from the wireless power supply apparatus 200c. With respect to the switching of the first state φ1 and the second state φ2, the control signal S3 includes at least one of the frequency information and the phase information. Description will be made in the second embodiment regarding an arrangement in which the control signal S3 includes both the frequency information and the phase information, i.e., an arrangement in which the control signal S3 indicates a switching timing at which the state is switched between the first state φ1 and the second state φ2. The control signal S3 is configured as a light signal, for example, which is configured as a pulse signal having a level that transits or an edge that occurs at every switching timing. With such an arrangement, as the receiver 32, a photodiode or a phototransistor may be employed. It is needless to say that the control signal S3 is not restricted to such a light signal. Also, the control signal S3 may be configured as a radio wave signal or a magnetic signal. With such an arrangement, the receiver 32 may be configured as a radio wave receiver including a coil.

The control unit 14 alternately switches the state of the bridge circuit 12c between the first state φ1 and the second state φ2 at a timing indicated by the control signal S3. The above is the configuration of the wireless power receiving apparatus 300c.

The wireless power supply apparatus 200c includes an AC power supply 10, a control signal generating unit 20, a transmission coil L1, and a transmitter 22.

The transmission coil L1 transmits an electric power signal S1. The AC power supply 10 generates an electric signal S2 having a predetermined frequency f, or subjected to frequency modulation, phase modulation, amplitude modulation, or the like. To facilitate understanding and for simplicity of explanation, in the present embodiment, the AC power supply 10 is taken to generate an AC signal having a constant frequency f.

The control signal generating unit 20 generates a control signal S3. As described above, the control signal S3 is a signal which instructs the wireless power receiving apparatus 300c to switch the state between the first state φ1 and the second state φ2. More specifically, the switching timing is determined by the switching frequency f (resonant frequency) and a switching phase θ.

The control signal generating unit 20 is capable of determining the resonant frequency f based upon the frequency f of the electric signal S2 generated by the AC power supply 10.

Furthermore, the control signal generating unit 20 is capable of determining the switching phase θ based upon the electric power consumption in the transmission coil L1, i.e., the electric power supplied to the reception coil L2. For example, if the coupling coefficient between the transmission coil L1 and the reception coil L2 is zero, the power consumption that occurs in the transmission coil L1 of the wireless power supply apparatus 200c is substantially zero. As the coupling coefficient between the transmission coil L1 and the reception coil L2 becomes higher, a greater amount of power consumption occurs in the transmission coil L1.

The control signal generating unit 20 is capable of determining the switching phase θ based upon the voltage V_{L1} applied to the transmission coil L1 and the current I_{L1} that flows through the transmission coil L1. That is to say, the control signal generating unit 20 is capable of controlling the switching phase θ such that the electric power that is the product of the voltage V_{L1} and the current I_{L1} approaches the maximum value or a desired value.

For example, in a case in which there is a desire to transmit the maximum electric power, the control signal generating unit 20 controls the phase θ of the control signal S3 such that the phase of the coil current I_{L1} matches the phase of the coil voltage V_{L1}. Conversely, by intentionally shifting the phase θ of the control signal S3 from the timing that provides the maximum transmission efficiency, such an arrangement is capable of limiting the electric power to be supplied.

The transmitter 22 converts the control signal S3 generated by the control signal generating unit 20 into a light signal, and transmits the light signal thus converted to the wireless power receiving apparatus 300c. The transmitter 22 may employ an LED (light emitting diode), a laser diode, or the like. In a case in which the control signal S3 is configured as an electromagnetic signal, the transmitter 22 should employ a radio wave transmitter.

The above is the configuration of the wireless power supply system 100c. Next, description will be made regarding the operation thereof.

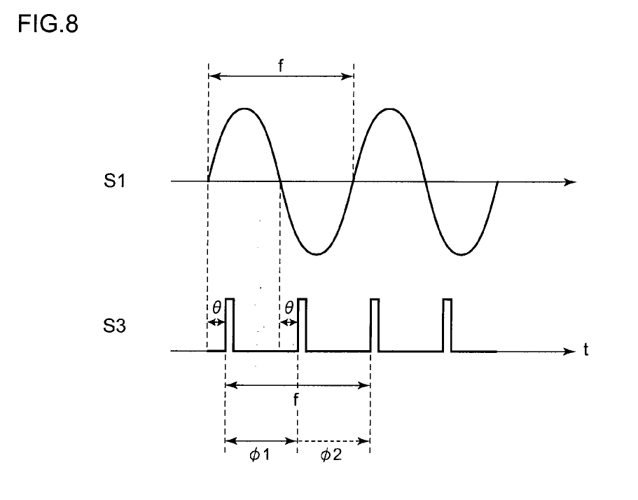

FIG. 8 is a time chart which shows the operation of the wireless power supply system 100c shown in FIG. 7.

The control signal S3 is configured as a pulse signal having a frequency that is double the frequency of the electric power signal S1, and having an edge at a switching timing of the bridge circuit 12c. There is a phase difference θ between the control signal S3 and the electric power signal S1. The control signal generating unit 20 controls the frequency of the control signal S3 according to the frequency of the electric power signal S1, and controls the phase θ of the control signal S3 with respect to the electric power signal S1.

With such an arrangement, the switching timing of the bridge circuit 12c included in the wireless power receiving apparatus 300c is controlled according to the control signal S3. Thus, such an arrangement allows the wireless power supply apparatus 200c to transmit the intended electric power.

In particular, in a case in which the wireless power supply system 100c is mounted on a mobile device, the phase θ required to transmit the same amount of electric power changes over time according to the distance between the transmission coil L1 and the reception coil L2, and according to each of their directions. Even in such a situation, the wireless power supply apparatus 200c is capable of monitoring the electric power transmitted from the transmission coil L1 to the reception coil L2. Thus, such an arrangement is capable of adaptively changing the phase θ so as to provide a constant supply of stable electric power.

Furthermore, in the wireless power receiving apparatus 300c, there is no need to detect the voltage V_{L2} that occurs at the reception coil L2, and there is no need to detect the current I_{L2} that flows through the reception coil L2, thereby providing a simple circuit configuration.

Moreover, with the present embodiment, even if the electric power signal S1 is modulated in a desired manner by the wireless power supply apparatus, the wireless power receiving apparatus is capable of appropriately receiving the electric power. The reason for this is because, in a case in which the electric power signal S1 is modulated, the optimum switching timing, at which the state of the wireless power receiving apparatus should switch between the first state φ1 and the second state φ2, changes over time. However, the wireless power receiving apparatus 300 is capable of following the change in the optimum switching timing based upon the control signal S3.

This means that such an arrangement allows the wireless power supply apparatus 200c to selectively transmit electric power only to the wireless power receiving apparatus 300c including the receiver 32 that corresponds to the transmitter 22 of the wireless power supply apparatus 200c.

Next, description will be made regarding modifications of the wireless power supply system 100c shown in FIG. 7.

### First Modification

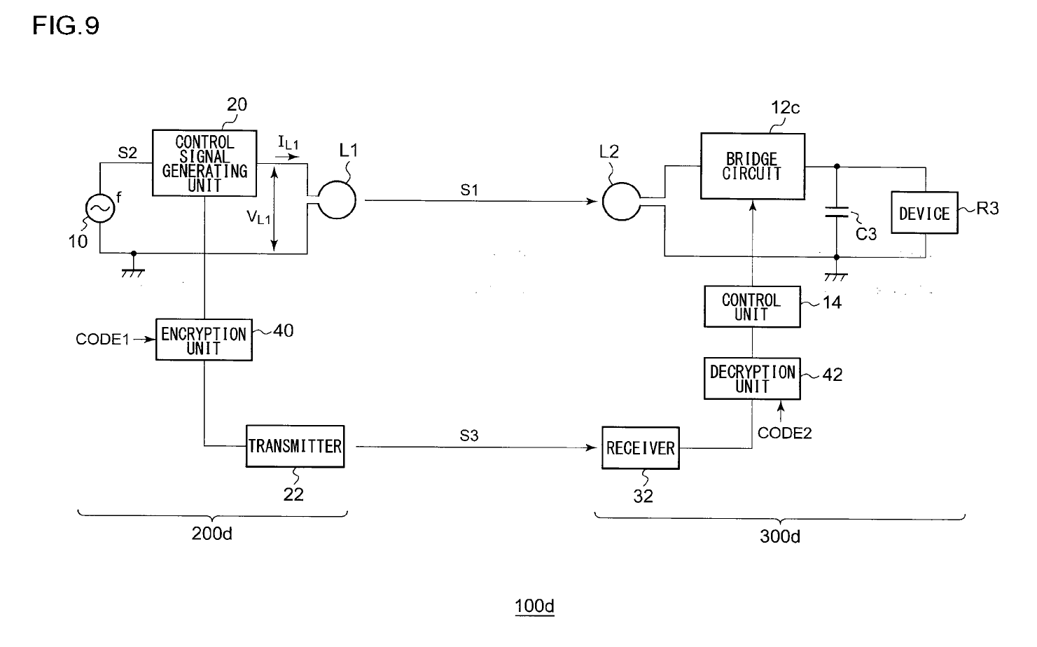

FIG. 9 is a diagram which shows a configuration of a wireless power supply system 100d according to a first modification.

A wireless power supply apparatus 200d includes an encryption unit 40 in addition to the configuration of the wireless power supply apparatus 200c shown in FIG. 7. The encryption unit 40 encrypts the control signal S3 based upon a predetermined encryption code CODE1. The transmitter 22 transmits the encrypted control signal S3.

A wireless power receiving apparatus 300d includes a decryption unit 42, in addition to the configuration of the wireless power receiving apparatus 300c shown in FIG. 7. The decryption unit 42 decrypts the encrypted control signal S3 based upon a decryption code CODE2. The control unit 14 controls the bridge circuit 12c based upon the control signal S3 thus decrypted.

The above is the configuration of the wireless power supply system 100d.

The wireless power supply system 100d allows only the wireless power receiving apparatus 300d having a valid decryption code CODE2 that corresponds to the encryption code CODE1 to receive electric power from the wireless power supply apparatus 200d. Furthermore, when the wireless power receiving apparatus 300d does not have such a valid decryption code CODE2, such an arrangement is capable of preventing electric power being supplied to such a wireless power receiving apparatus 300d. The wireless power supply system 100d can be suitably applied to a system in which users are charged for receiving the power supply.

### Second Modification

With the wireless power supply system shown in FIG. 7 or 9, the control signal S3 including both the frequency information and the phase information is transmitted together with the electric power signal S1. In contrast, description will be made below regarding a second modification in which the control signal S3 includes only the frequency information.

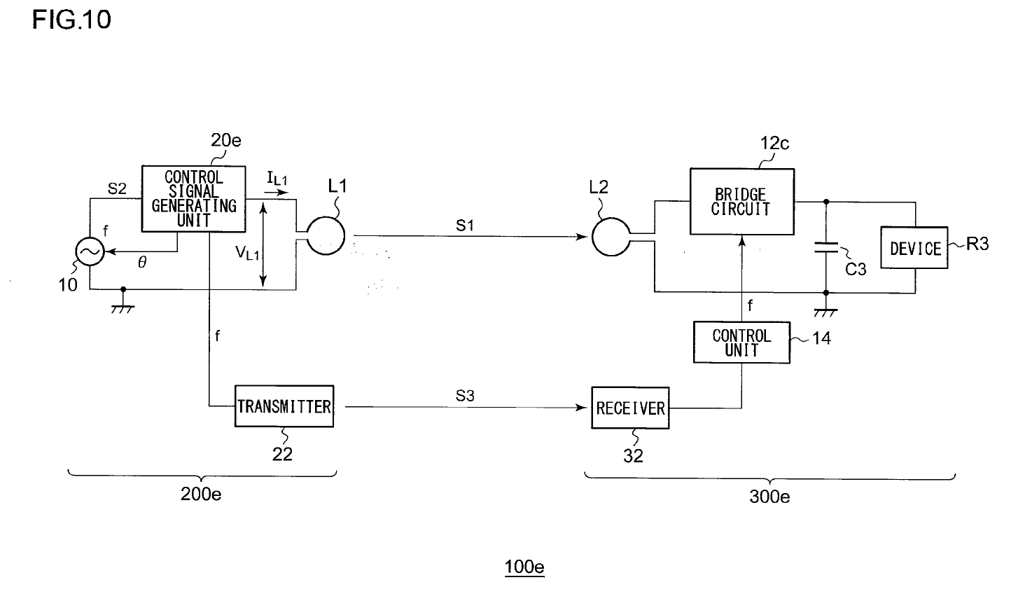

FIG. 10 is a diagram which shows a wireless power supply system 100e according to a second modification.

The control signal S3 includes digital data which indicates the frequency of the electric power signal S1. The control unit 14 switches the bridge circuit 12c at a frequency indicated by the control signal S3. The control unit 14 does not control the phase θ of the switching of the bridge circuit 12c. That is to say, the control unit 14 performs switching of the bridge circuit 12c with an arbitrary phase.

The power supply 10 included in a wireless power supply apparatus 200e is configured so as to be capable of adjusting the phase of the electric signal S2. In a state in which the bridge circuit 12c is switched with a fixed phase, the control signal generating unit 20e sweeps the phase θ of the electric signal S2 while monitoring the power consumption of the transmission coil L1. This is equivalent to an arrangement in which the phase of the switching of the bridge circuit 12c is controlled. Thus, the Q value in the bridge circuit 12c is changed according to the phase θ, thereby changing the coupling coefficient between the transmission coil L1 and the reception coil L2.

Thus, with the second modification, by controlling the AC power supply 10 so as to adjust the phase of the electric signal S2, i.e., the phase of the electric power signal S1, such an arrangement is capable of supplying desired electric power.

### Third Embodiment

Description has been made in the second embodiment regarding the wireless power receiving apparatus 300c including the bridge circuit 12c. Description will be made regarding a wireless power receiving apparatus 300f including a resonance circuit.

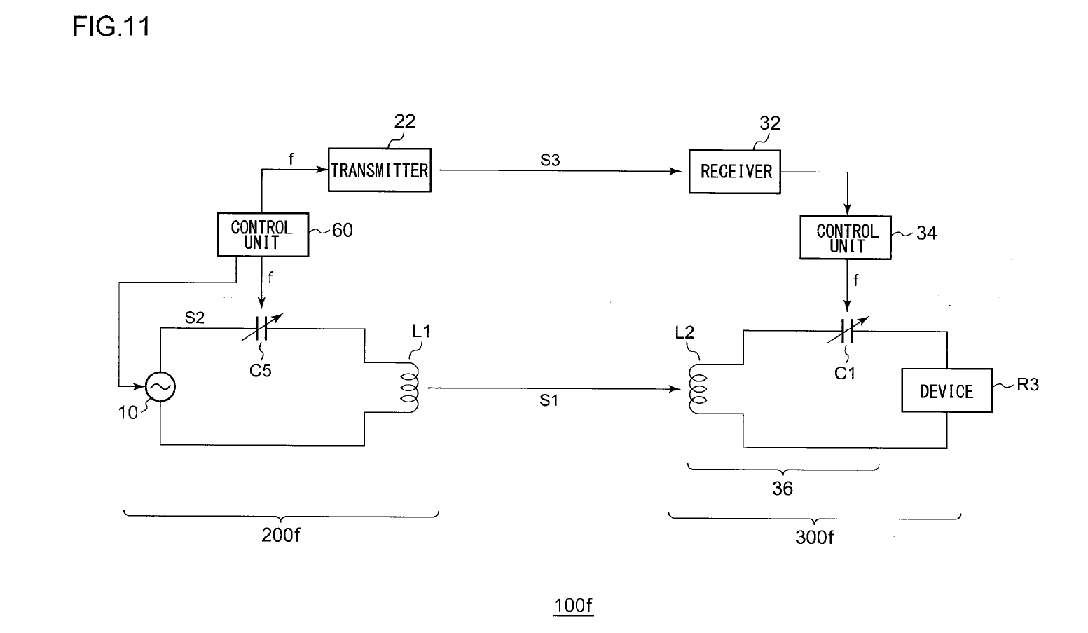

FIG. 11 is a diagram which shows a configuration of a wireless power supply system 100f according to the third embodiment. A wireless power supply apparatus 200f is configured to be capable of changing the frequency of the electric power signal S1. A control unit 60 controls the AC power supply 10 so as to control the frequency f of the electric power signal S1. Furthermore, the control unit 60 controls the capacitance of a transmission capacitor C5 according to the frequency f of the electric power signal S1 so as to tune the resonant frequency of the transmission antenna (L1, C5). The transmitter 22 transmits the electric power signal S1 and the control signal S3 which indicates the frequency f of the electric power signal S1.

The receiver 32 receives the control signal S3. A resonance capacitor C1 and a reception coil L2 form a resonance circuit 36, which is configured such that the resonant frequency thereof is tunable. The control unit 34 changes the impedance of the resonance circuit 36 according to the control signal S3 such that resonance occurs between the resonance circuit 36 and the electric power signal S1.

With the wireless power supply system 100f according to the third embodiment, the wireless power receiving apparatus 300f does not require a circuit configured to detect the voltage or current that occurs at the reception coil L2. Furthermore, such an arrangement is capable of precisely tuning the impedance of the resonance circuit 36.

Furthermore, with the present embodiment, even in a case in which the electric power signal S1 is modulated in a desired manner, the wireless power receiving apparatus is capable of appropriately receiving the electric power. The reason is because, in a case in which the electric power signal S1 is modulated, the resonant frequency (impedance of the resonance circuit 36), which is to be set in the wireless power receiving apparatus, changes over time. However, the wireless power receiving apparatus is capable of following the change in the resonant frequency based upon the control signal S3.

This means that such an arrangement allows the wireless power supply apparatus 200f to selectively transmit electric power only to a wireless power receiving apparatus 300f including the receiver 32 that corresponds to the transmitter 22 of the wireless power supply apparatus 200f.

It should be noted that the wireless power supply apparatus 200f and the wireless power receiving apparatus 300f shown in FIG. 11 may include an encryption unit 40 and a decryption unit 42, respectively. Such an arrangement allows the wireless power supply apparatus 200f to selectively supply electric power only to a wireless power receiving apparatus having a decryption key.

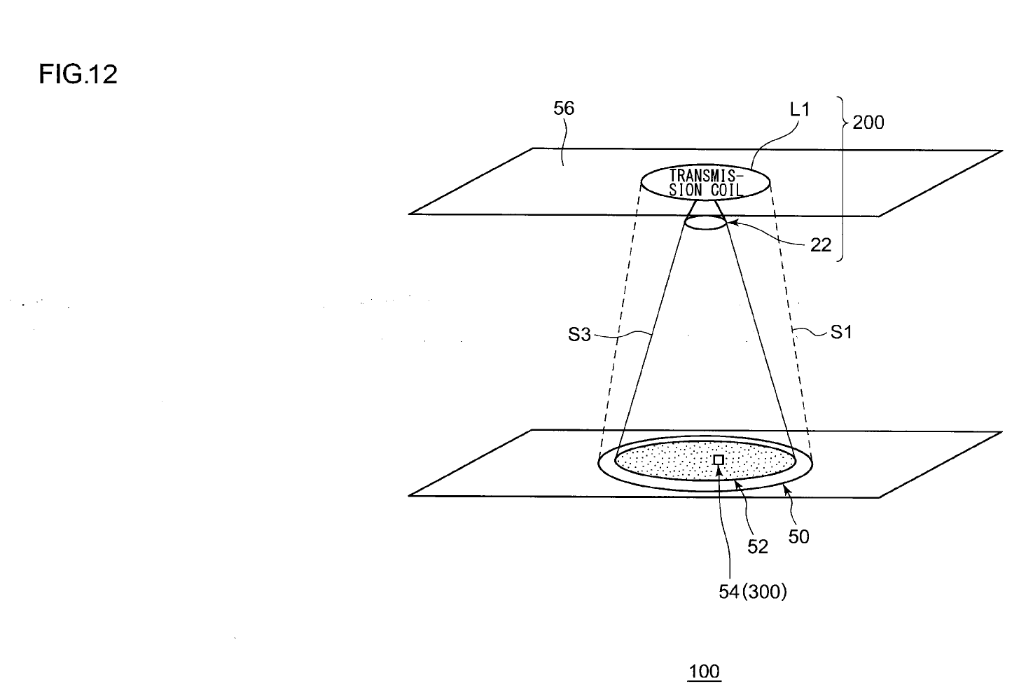

FIG. 12 is a diagram which shows an example of an installation of the wireless power supply system according to the second or third embodiment. Any one of the wireless power supply apparatuses 200c through 200f (which will be collectively referred to as the “wireless power supply apparatus 200”) is installed on the ceiling 56.

In a case in which the electric power signal S1 transmitted from the transmission coil L1 has a certain level of directionality, a device 54 mounting any one of the wireless power receiving apparatuses 300c through 300f (which will be collectively referred to as the “wireless power receiving apparatus 300”) can receive electric power only within an area 50, and cannot receive electric power outside the area 50.

With such an arrangement, the control signal S3 output from the transmitter 22 is configured as a visible light signal, and its illumination area 52 is set so as to approximately coincide with the area 50. The control signal S3 is switched at a frequency that is sufficiently higher than what can be perceived by a human being. Accordingly, the user recognizes the control signal S3 simply as illumination. By relying on the control signal S3 configured as a visible light signal, the user of the device 54 can move the device 54 into the area 50 in which the device 54 can receive electric power. The electric power signal S1 is invisible to a human being. Thus, it is very effective to configure the control signal S3 as a visible light signal, which can be used as a landmark indicating the area 50 in which the device 54 can receive electric power.

Also, the installation arrangement shown in FIG. 10 can be used in handover in a case in which multiple transmission coils L1 are installed. Also, such an arrangement allows poor transmission efficiency points (NULL points) to be marked without the explicit awareness of the user.

The control unit 14 may be configured to provide, as states which can be switched according to the control signal S3, at least one of a third state φ3 and a fourth state φ4 in addition to the first state φ1 and the second state φ2. In the third state φ3, both the first switch SW1 and the second switch SW2 are on. In the fourth state φ4, both the third switch SW3 and the fourth switch SW4 are on.

In the third state φ3 or the fourth state φ4, the reception coil L2, the resonance capacitor C1, and the two switches in the on state SW1 and SW2 (or otherwise SW3 and SW4), are connected in series to form a resonance loop, thereby providing the highest Q value.

The control unit 14 may be configured to provide, as a state which can be switched according to the control signal S3, a fifth state φ5 in which all the switches from the first switch SW1 through the fourth switch SW4 are off, in addition to the first state φ1 and the second state φ2. By providing such a fifth state φ5 during transition from the first state φ1 to the second state φ2 and during transition from the second state φ2 to the first state φ1, and by adjusting the length of the fifth state (which will be referred to as “dead time” or the “dead band”) while maintaining the switching period at a constant length, such an arrangement is capable of adjusting the effective resonant frequency without changing the circuit constants of the reception coil L2 and the resonance capacitor C1.

While the preferred embodiments of the present invention have been described using specific terms, such description is for illustrative purposes only, and it is to be understood that changes and variations may be made without departing from the spirit or scope of the appended claims.

What is claimed is:

1. A wireless power receiving apparatus configured to receive an electric power signal, including any one of an electric field, a magnetic field, and an electromagnetic field, the wireless power receiving apparatus comprising:
a reception coil configured to receive the electric power signal;
a bridge circuit connected to the reception coil, and configured such that the on/off state of each internal switch thereof is capable of switching between a first state and a second state;
a receiver configured to receive a control signal which is transmitted from the power supply apparatus, and which includes at least one of frequency information and phase information with respect to switching between the first state and the second state; and
a control unit configured to switch the state of the bridge circuit between the first state and the second state according to the control signal.

2. A wireless power receiving apparatus according to claim 1, wherein the control signal is configured as a pulse signal which indicates a switching timing of switching between the first state and the second state.

3. A wireless power receiving apparatus according to claim 1, wherein the control signal includes frequency information with respect to switching between the first state and the second state.

4. A wireless power receiving apparatus according to claim 1, wherein the control signal is configured as a light signal.

5. A wireless power receiving apparatus according to claim 1, wherein the control signal is encrypted,
and wherein the wireless power receiving apparatus further comprises a decryption unit configured to decrypt the control signal received by the receiver.

6. A wireless power receiving apparatus according to claim 1, wherein the bridge circuit comprises:
a first switch and a second switch sequentially arranged in series so as to form a closed loop together with the reception coil, and arranged such that a connection node that connects the first switch and the second switch is connected to a second terminal of a capacitor arranged such that a first terminal thereof is set to a fixed electric potential; and
a third switch and a fourth switch sequentially arranged in series so as to form a path arranged in parallel with the first switch and the second switch, and arranged such that a connection node that connects the third switch and the fourth switch is set to a fixed electric potential,
and wherein the control unit is configured to switch the state, at a timing indicated by the control signal, between a first state in which the first switch and the fourth switch are on and the second switch and the third switch are off, and a second state in which the first switch and the fourth switch are off and the second switch and the third switch are on.

7. A wireless power receiving apparatus according to claim 6, wherein the first switch and the second switch form a closed loop together with an auxiliary coil densely coupled with the reception coil, instead of the reception coil.

8. A wireless power supply apparatus configured to transmit, to a wireless power receiving apparatus, an electric power signal, including any one of an electric field, a magnetic field, and an electromagnetic field, wherein the wireless power receiving apparatus comprises:
a reception coil configured to receive the electric power signal;
a capacitor arranged such that a first terminal thereof is set to a fixed electric potential;
a bridge circuit arranged between the reception coil and the capacitor, and configured such that the on/off state of each internal switch thereof is capable of switching between a first state and a second state;
a receiver configured to receive a control signal which is transmitted from the power supply apparatus, and which includes at least one of frequency information and phase information with respect to switching between the first state and the second state; and
a control unit configured to switch the state of the bridge circuit between the first state and the second state according to the control signal,
and wherein the wireless power supply apparatus comprises:
a transmission coil configured to transmit the electric power signal;
a control signal generating unit configured to generate the control signal; and
a transmitter configured to transmit the control signal.

9. A wireless power supply apparatus according to claim 8, wherein the control signal is configured as a pulse signal which indicates a switching timing of switching between the first state and the second state.

10. A wireless power supply apparatus according to claim 9, wherein the control signal generating unit is configured to determine, based upon a voltage applied to the transmission coil and a current that flows through the transmission coil, a timing of switching the state between the first state and the second state.

11. A wireless power supply apparatus according to claim 8, wherein the control signal includes only frequency information with respect to switching between the first state and the second state,
and wherein the wireless power supply apparatus adjusts the phase of the electric power signal transmitted from the transmission coil, based upon a voltage applied to the transmission coil and a current that flows through the transmission coil.

12. A wireless power supply apparatus according to claim 8, wherein the control signal is configured as a visible light signal,
and wherein the transmitter is configured to emit the visible light signal in an area in which the wireless power receiving apparatus can receive the electric power signal.

13. A wireless power supply apparatus according to claim 8, further comprising an encryption unit configured to encrypt the control signal.

14. A wireless power supply system comprising:
a wireless power supply apparatus; and
a wireless power receiving apparatus according to claim 1, configured to receive the electric power signal from the wireless power supply apparatus.

15. A wireless power supply system comprising:
a wireless power supply apparatus according to claim 8; and
a wireless power receiving apparatus according to claim 1, configured to receive an electric power signal from the wireless power supply apparatus.

16. A wireless power receiving apparatus configured to receive an electric power signal, including any one of an electric field, a magnetic field, and an electromagnetic field, the wireless power receiving apparatus comprising:
a reception coil configured to receive the electric power signal;
a resonance capacitor arranged such that it forms a resonance circuit together with the reception coil;
a receiver configured to receive a control signal which is transmitted from the power supply apparatus, and which indicates the frequency of the electric power signal; and
a control unit configured to change the impedance of the resonance circuit according to the control signal such that resonance occurs between the resonance circuit and the electric power signal.

17. A wireless power receiving apparatus according to claim 16, wherein the control signal is encrypted,
and wherein the wireless power receiving apparatus further comprises a decryption unit configured to decrypt the control signal received by the receiver.

18. A wireless power supply apparatus configured to transmit an electric power signal including any one of an electric field, a magnetic field, and an electromagnetic field, wherein the wireless power receiving apparatus comprises:
a reception coil configured to receive the electric power signal;
a resonance capacitor arranged to form a resonance circuit together with the reception coil;
a receiver configured to receive a control signal transmitted from the power supply apparatus, and indicating the frequency of the electric power signal; and
a control unit configured to change the impedance of the resonance circuit according to the control signal such that resonance occurs between the resonance circuit and the electric power signal,
and wherein the wireless power supply apparatus comprises:
a transmission coil configured to transmit the electric power signal;
a control signal generating unit configured to generate the control signal; and
a transmitter configured to transmit the control signal.

19. A wireless power supply apparatus according to claim 18, further comprising an encryption unit configured to encrypt the control signal.

20. A wireless power supply apparatus according to claim 18, wherein the control signal is configured as a visible light signal,
and wherein the transmitter is configured to emit the visible light signal in an area in which the wireless power receiving apparatus can receive the electric power signal.

21. A wireless power supply system comprising:
a wireless power supply apparatus; and
a wireless power receiving apparatus according to claim 18, configured to receive an electric power signal from the wireless power supply apparatus.

22. A wireless power supply system comprising:
a wireless power receiving apparatus according to claim 16; and
a wireless power supply apparatus configured to receive an electric power signal from the wireless power supply apparatus.
